(19) United States
(12) Patent Application Publication
(10) Pub. No.: US 2025/0297118 A1
(43) Pub. Date: Sep. 25, 2025

(54) AQUEOUS INK, INK CARTRIDGE AND INK JET RECORDING METHOD

(71) Applicant: CANON KABUSHIKI KAISHA, Tokyo (JP)

(72) Inventors: HIROYOSHI TOBISE, Kanagawa (JP); HIROSHI KAKIKAWA, Kanagawa (JP); SATORU KOBAYASHI, Kanagawa (JP)

(21) Appl. No.: 19/083,721

(22) Filed: Mar. 19, 2025

(30) Foreign Application Priority Data
Mar. 21, 2024 (JP) 2024-044876
Feb. 18, 2025 (JP) 2025-024416

(51) Int. Cl. C09D 11/326; C08K 3/04; C09D 11/38

(52) U.S. Cl. CPC C09D 11/326; C08K 3/04; C09D 11/38; C08K 2201/005; C08K 2201/011

(57) ABSTRACT

Provided is an aqueous ink for ink jet capable of recording an image having a high optical density, in which the non-ejection of the ink is less liable to occur, even when an image having a large ink consumption amount is continuously recorded. The aqueous ink for ink jet includes: a first pigment; a second pigment; and a surfactant. The first pigment and the second pigment are each self-dispersible carbon black in which an organic group including an anionic group is bonded to a surface of a particle of carbon black. A ratio of a cumulative 50% particle diameter (nm) of the first pigment on a volume basis to a cumulative 50% particle diameter (nm) of the second pigment on a volume basis is 1.3 times or more, and the cumulative 50% particle diameter of the second pigment on a volume basis is 60 nm or less.

### BACKGROUND OF THE INVENTION

### Field of the Invention

The present invention relates to an aqueous ink, an ink cartridge and an ink jet recording method.

### Description of the Related Art

In recent years, an ink jet recording method has been adopted for recording images for commercial and industrial use, as well as for recording documents for home and office use. In particular, there is an increasing need for the application in which an image that develops high color is continuously recorded on a recording medium, such as plain paper or coated paper, through use of an ink jet recording apparatus capable of performing recording even on a large-sized recording medium such as A3 paper, and various inks suitable for such application have been developed.

In an ink for recording an image on a recording medium, such as plain paper or coated paper, there are requirements that the ink have high aggregability, hardly permeate the recording medium in a thickness direction, and be capable of recording a high-quality image having a high optical density. In addition, in order to satisfy such requirements, there has been widely used an aqueous ink including, as a coloring material, self-dispersible carbon black in which an anionic functional group is directly bonded to a surface of a particle of carbon black. For example, there has been proposed an ink using two kinds of self-dispersible carbon blacks having different dibutyl phthalate (DBP) oil absorptions in order to record an image having a high optical density (Japanese Patent Application Laid-Open Nos. 2018-021099 and 2002-003767).

The inventors of the present invention have investigated the inks proposed in Japanese Patent Application Laid-Open Nos. 2018-021099 and 2002-003767 in order to continuously record an image having a high optical density on a recording medium, such as plain paper or coated paper. As a result, it has been found that, when an image having a large ink consumption amount such as a solid image is continuously recorded through use of those inks, ejection failure occurs, and density unevenness and blurring of the image are liable to occur. Then, the cause for the occurrence of such ejection failure has been investigated, and it has been found that non-ejection of an ink is liable to occur owing to air bubbles mixed in an ink flow path of a recording head.

### SUMMARY OF THE INVENTION

Accordingly, an object of the present invention is to provide an aqueous ink for ink jet capable of recording an image having a high optical density, in which the non-ejection of the ink is less liable to occur, even when an image having a large ink consumption amount is continuously recorded. Another object of the present invention is to provide an ink cartridge and an ink jet recording method each using the aqueous ink.

That is, according to the present invention, there is provided an aqueous ink for ink jet including: a first pigment; a second pigment; and a surfactant, wherein the first pigment and the second pigment are each self-dispersible carbon black in which an organic group including an anionic group is bonded to a surface of a particle of carbon black, and wherein a ratio of a cumulative 50% particle diameter (nm) of the first pigment on a volume basis to a cumulative 50% particle diameter (nm) of the second pigment on a volume basis is 1.3 times or more, and the cumulative 50% particle diameter of the second pigment on a volume basis is 60 nm or less.

Further features of the present invention will become apparent from the following description of exemplary embodiments with reference to the attached drawings.

### BRIEF DESCRIPTION OF THE DRAWINGS

FIG. 1 is a sectional view for schematically illustrating an ink cartridge according to one embodiment of the present invention.

FIGS. 2A and 2B are views for schematically illustrating an example of an ink jet recording apparatus to be used in an ink jet recording method of the present invention. FIG. 2A is a perspective view of the main portion of the ink jet recording apparatus and FIG. 2B is a perspective view of a head cartridge.

### DESCRIPTION OF THE EMBODIMENTS

The present invention is described in more detail below by way of exemplary embodiments. In the present invention, when a compound is a salt, the salt is present in a state of dissociating into ions in an ink, but the expression “includes the salt” is used for convenience. In addition, an aqueous ink for ink jet is sometimes simply described as “ink”. Physical property values are values at normal temperature (25° C.) unless otherwise stated.

The inventors of the present invention have presumed the reason why the non-ejection of an ink is liable to occur owing to air bubbles mixed in an ink flow path of a recording head when an image having a large ink consumption amount such as a solid image is continuously recorded as described below. When an image having a large ink consumption amount is continuously recorded, the flow rate of an ink in the ink flow path of the recording head is increased, and a plurality of air bubbles tend to gather in a portion in which the air bubbles are easily accumulated in the ink flow path. Further, it has been found that, in an ink including a compound such as a surfactant, the compound having a hydrophobic portion and a hydrophilic portion present in a molecule thereof, air bubbles tend to be present stably. This is because, when the hydrophobic portion of the surfactant is oriented to the air side of the inside of each of the air bubbles each having high hydrophobicity, and the hydrophilic portion of the surfactant is oriented to the ink side thereof, the stability of a film of the air bubble interface is increased. In addition, it is conceived that, when the air bubbles reach a flow path communicating to individual ejection orifices of the recording head, the non-ejection occurs.

Next, the inventors of the present invention have investigated an ink free of a surfactant. However, it has been found that the wettability of the ink with respect to the recording head becomes insufficient, resulting in a deviation in an ink ejection direction and a decrease in ejection accuracy. Consequently, it is conceived that it is required to decrease the stability of air bubbles also in an ink including a surfactant.

The inventors of the present invention have focused on and further investigated the particle diameter of carbon black in order to decrease the stability of the air bubbles in the ink including a surfactant to improve the ejection stability of the ink. As a result, the inventors have found that, when the following requirements (i) to (iv) are satisfied, the stability of the air bubbles is decreased, and the ejection accuracy is less liable to be decreased even when an image having a large ink consumption amount is continuously recorded, and the ejection stability is improved. Thus, the inventors have reached the present invention.

(i) An aqueous ink for ink jet includes: a first pigment; a second pigment; and a surfactant.

(ii) The first pigment and the second pigment are each self-dispersible carbon black in which an organic group including an anionic group is bonded to a surface of a particle of carbon black.

(iii) A ratio of a cumulative 50% particle diameter (nm) of the first pigment on a volume basis to a cumulative 50% particle diameter (nm) of the second pigment on a volume basis is 1.3 times or more.

(iv) The cumulative 50% particle diameter of the second pigment on a volume basis is 60 nm or less.

The inventors of the present invention have assumed the mechanism by which the above-mentioned effects are obtained as described below. When a plurality of generated air bubbles come close to each other in an ink, the air bubbles push each other, and a film is formed so that the ink may be sandwiched between the air bubbles. With the passage of time, the ink is discharged from the formed film, and the film gradually becomes thinner. Eventually, the film cannot be maintained any more, and the air bubbles are broken by the impact of the rupture of the film. However, as described above, the presence of a surfactant increases the stability of the film and makes it difficult for the air bubbles to be broken. Here, when carbon black having high hydrophobicity is present in the film formed so as to be sandwiched between air bubbles, the surfactant adsorbs to the hydrophobic portion of a surface of a particle of the carbon black, and the stability of the film is decreased, with the result that the air bubbles are easily broken. While a carbon black particle having a relatively large particle diameter shows bubble-breaking action in a stage in which the film is thick, the carbon black particle cannot enter the film that has become thinner with the passage of time. In view of the foregoing, when carbon black having a relatively small particle diameter of 60 nm or less is further incorporated, the particle of the carbon black having a particle diameter of 60 nm or less enters even the film that has become thinner, thereby being capable of improving the bubble-breaking efficiency. As a result, it is conceived that, even when an image having a large ink consumption amount such as a solid image is continuously recorded, the ejection accuracy is less liable to be decreased, and the ejection stability is improved.

### <Aqueous Ink>

The ink of the present invention is an aqueous ink for ink jet including: a first pigment; a second pigment; and a surfactant. The first pigment and the second pigment are each self-dispersible carbon black in which an organic group including an anionic group is bonded to a surface of a particle of carbon black. In addition, a ratio of a cumulative 50% particle diameter (nm) of the first pigment on a volume basis to a cumulative 50% particle diameter (nm) of the second pigment on a volume basis is 1.3 times or more, and the cumulative 50% particle diameter of the second pigment on a volume basis is 60 nm or less. The physical properties of each component for forming the ink and the ink are described below in detail.

### (Self-Dispersible Carbon Black)

The ink includes the first pigment and the second pigment. The first pigment and the second pigment are each self-dispersible carbon black in which an organic group including an anionic group is bonded to the surface of a particle of the carbon black. When it is not required to particularly distinguish between the pigments, the pigments may be hereinafter described without distinction. With regard to the conditions under which it is not required to distinguish between the pigments, it is preferable that each of the pigments satisfy the conditions.

### [Organic Group Including Anionic Group]

The organic group bonded to the surface of the particle of the carbon black is an anionic group or a group in which another atomic group and an anionic group are bonded to each other (hereinafter sometimes simply referred to as “functional group”). Examples of the anionic group may include a carboxylic acid group, a sulfonic acid group, a phosphoric acid group and a phosphonic acid group. In particular, it is preferable that the anionic group be a carboxylic acid group. In addition, it is preferable that the first pigment and the second pigment be each self-dispersible carbon black in which an organic group including a carboxylic acid group is bonded to the surface of the particle of the carbon black. When the kinds of the anionic groups of the first pigment and the second pigment are different, the difference in aggregability between the first pigment and the second pigment may become larger. As a result, the distribution of the pigments in an image may occur, and an improving effect on an optical density may be slightly decreased. In addition, when the anionic group is a group other than a carboxylic acid group, the aggregability of each of the first pigment and the second pigment may be decreased, and an improving effect on the optical density of an image may be slightly decreased.

When the anionic group forms a salt, at least one proton in the anionic group is substituted with a cation (counter ion). Examples of the counter ion may include an alkali metal ion, an ammonium ion and an organic ammonium ion. Examples of the alkali metal ion may include ions of lithium, sodium and potassium. Examples of the organic ammonium ion may include: cations of aliphatic amines, such as mono to trialkylamines; and cations of aliphatic alcohol amines, such as mono to trialkanolamine. The counter ion is preferably a potassium ion or an ammonium ion out of those ions. In addition, it is preferable that the counter ion of each of the first pigment and the second pigment be a potassium ion or an ammonium ion, and that the counter ions of the first pigment and the second pigment be the same kind. When the kinds of the counter ions are different, the difference in aggregability between the first pigment and the second pigment may become larger. As a result, the distribution of the pigments in an image may occur, and an improving effect on an optical density may be slightly decreased. In addition, when the counter ion is an ion other than a potassium ion and an ammonium ion, the storage stability of the ink may be slightly decreased.

Examples of the other atomic group may include: an alkylene group, such as a methylene group, an ethylene group or a propylene group; an arylene group, such as a phenyl group, a naphthyl group, an anthracenyl group, a phenanthrenyl group or a biphenyl group; a heteroarylene group, such as a pyridylene group, an imidazolylene group, a pyrazolylene group, a pyridinylene group, a thienylene group or a thiazolylene group; a carbonyl group; an ester group, such as a carboxylic acid ester group, a sulfonic acid ester group, a phosphoric acid ester group or a phosphonic acid ester group; an imino group; an amide group; a sulfonyl group; and an ether group. In addition, a group obtained by combining those groups may also be adopted.

It is preferable to use a self-dispersible pigment in which an anionic group is bonded to the surface of the particle of the pigment through another atomic group, rather than a self-dispersible pigment in which an anionic group is directly bonded to the surface of the particle of the pigment (carbon black). The surface of the particle of the carbon black is in various states, and hence an anionic group directly bonded to the surface of the particle also has a variety of properties. An anionic group in a state of being easily oxidized may be generated, and the self-dispersible carbon black itself may be easily oxidized. Thus, it is preferable to use self-dispersible carbon black in which an anionic group is bonded to the surface of the particle of the carbon black through another atomic group. In particular, it is preferable to use a self-dispersible pigment in which a structure derived from phthalic acid [—C₆H₄—(COOM)₂ (M represents a counter ion described above)] is bonded to the surface of the particle of the pigment. In particular, both of the first pigment and the second pigment are preferably self-dispersible pigments in which a structure derived from phthalic acid is bonded to the particle surface of the pigment.

### [Kind of Carbon Black]

Examples of the carbon black may include furnace black, lamp black, acetylene black and channel black.

### [Average Particle Diameter]

The ratio of a cumulative 50% particle diameter (nm) of the first pigment on a volume basis to a cumulative 50% particle diameter (nm) of the second pigment on a volume basis is 1.3 times or more, preferably 1.5 times or more to 3.0 times or less, particularly preferably 1.5 times or more to 2.5 times or less. When the above-mentioned ratio is 1.3 times or more, the bubble-breaking action of the first pigment in a stage in which a film formed so as to be sandwiched between air bubbles is thick and the bubble-breaking action of the second pigment in the film that has become thinner with the passage of time may be obtained efficiently. That is, in the case where the above-mentioned ratio is 1.3 times or more, even when an image having a large ink consumption amount such as a solid image is continuously recorded, the non-ejection of an ink caused by the mixed air bubbles can be suppressed.

The cumulative 50% particle diameter (average particle diameter) of the first pigment on a volume basis is preferably 80 nm or more. When the average particle diameter of the first pigment is less than 80 nm, the amount of the first pigment that permeates a recording medium in a thickness direction may be increased, and an improving effect on an optical density may be decreased. In addition, the average particle diameter of the first pigment is preferably 150 nm or less, more preferably 130 nm or less. When the average particle diameter of the first pigment is more than 150 nm, an improving effect on the storage stability of the ink may be decreased.

The cumulative 50% particle diameter (average particle diameter) of the second pigment on a volume basis is 60 nm or less. When the average particle diameter of the second pigment is 60 nm or less, carbon black having an average particle diameter of 60 nm or less enters the film of air bubbles that has become thinner with the passage of time, and hence the air bubbles can be efficiently broken. Even when an image having a large ink consumption amount such as a solid image is continuously recorded, the non-ejection of the ink caused by the mixed air bubbles can be suppressed. The average particle diameter of the second pigment is preferably 40 nm or more, more preferably 45 nm or more. When the average particle diameter of the second pigment is less than 40 nm, the amount of the second pigment that permeates a recording medium in a thickness direction may be increased, and an improving effect on an optical density may be decreased.

The simple term “average particle diameter” as used herein means a “cumulative 50% particle diameter (D50) on a volume basis.” The “cumulative 50% particle diameter on a volume basis” refers to the diameter of a particle that accounts for 50% of the total volume of the measured particles, the ratio being calculated by integration from the small particle diameter side, in a particle diameter integration curve measured by a dynamic light scattering method. The average particle diameter of the pigment in the ink may be identified, for example, as described below. First, the particle diameter distribution of the pigment in the ink is measured with a particle diameter measuring device. As the particle diameter measuring device to be used in this case, a device based on a dynamic light scattering system, a disk centrifugal system, a scanning mobility measuring system or the like may be used. Alternatively, the particle diameter distribution may also be measured by performing image processing on an image observed with a transmission electron microscope or a scanning electron microscope. When two or more local maximum particle diameters are present in the particle diameter distribution of the pigment measured through use of the ink, and the ratio of the local maximum particle diameters is 1.3 times or more, it can be determined that the requirement of the ratio specified in the present invention is satisfied, and the effects of the present invention described above can be obtained.

### [Anionic Group Amount]

The anionic group amount (mmol/g) of the pigment is a physical property value that can be utilized as an indicator indicating the amount of an anionic group in self-dispersible carbon black, and the amount may be measured by colloidal titration. The anionic group amount of the first pigment is preferably 0.10 mmol/g or more to 0.18 mmol/g or less, more preferably 0.13 mmol/g or more to 0.18 mmol/g or less. When the anionic group amount of the first pigment is less than 0.10 mmol/g, an improving effect on the storage stability of the ink may be decreased. Meanwhile, when the anionic group amount of the first pigment is more than 0.18 mmol/g, the aggregability of the first pigment may be decreased, and an improving effect on an optical density may be slightly decreased.

The anionic group amount of the second pigment is preferably 0.27 mmol/g or less. When the anionic group amount of the second pigment is more than 0.27 mmol/g, a state in which the surface of the particle of the carbon black is mostly covered with an organic group including an anionic group is established, and the ratio of the “hydrophobic portion” in which an anionic group is not present on the surface of the particle is decreased. As a result, the surfactant does not easily adsorb, and when an image having a large ink consumption amount such as a solid image is continuously recorded, a suppressing effect on the non-ejection may be decreased. The anionic group amount of the second pigment is preferably 0.18 mmol/g or more, more preferably 0.20 mmol/g or more. When the anionic group amount of the second pigment is less than 0.18 mmol/g, an improving effect on the storage stability of the ink may be decreased.

The anionic group amount (mmol/g) of the second pigment is preferably 1.1 times or more to 2.0 times or less, more preferably 1.1 times or more to 1.8 times or less in terms of ratio to the anionic group amount (mmol/g) of the first pigment. The second pigment is a particle smaller than the first pigment, and hence the second pigment relatively easily permeates a recording medium in a thickness direction. It is assumed that, when the aggregability of the first pigment is relatively high, the permeation of the second pigment into the recording medium in the thickness direction is suppressed by the pore-sealing effect of an aggregate of the first pigment formed in advance, and the optical density of an image is increased. Here, when the above-mentioned ratio is less than 1.1 times, the aggregability of the second pigment becomes equivalent to or more than the aggregability of the first pigment, with the result that the pore-sealing effect of the aggregate of the first pigment may be decreased, and an improving effect on an optical density may be slightly decreased. Meanwhile, when the above-mentioned ratio is more than 2.0 times, the difference in aggregability between the first pigment and the second pigment may become excessive to cause a distribution of the pigments in the image, and an improving effect on an optical density may be slightly decreased.

### [Content]

The content (% by mass) of each pigment in the ink is preferably 0.10% by mass or more to 10.00% by mass or less with respect to the total mass of the ink. The content (% by mass) of the first pigment in the ink is preferably 1.00% by mass or more to 8.00% by mass or less, more preferably 2.00% by mass or more to 5.00% by mass or less with respect to the total mass of the ink. In addition, the content (% by mass) of the second pigment in the ink is preferably 0.10% by mass or more to 5.00% by mass or less, more preferably 0.50% by mass or more to 1.80% by mass or less with respect to the total mass of the ink.

The content (% by mass) of the first pigment in the ink is preferably 1.5 times or more to 5.0 times or less, more preferably 2.0 times or more to 4.0 times or less in terms of mass ratio to the content (% by mass) of the second pigment. When the above-mentioned mass ratio is less than 1.5 times, the pore-sealing effect of the aggregate of the first pigment may be decreased. Thus, the second pigment easily permeates a recording medium in a thickness direction, and an improving effect on the optical density of an image may be slightly decreased. Meanwhile, when the above-mentioned mass ratio is more than 5.0 times, the number of particles of the second pigment that can enter the film of air bubbles that has become thinner with the passage of time is reduced. As a result, when an image having a large ink consumption amount such as a solid image is continuously recorded, a suppressing effect on the non-ejection may be decreased.

### [DBP Oil Absorption]

The DBP oil absorption of the carbon black is preferably 30 mL/100 g or more to 200 mL/100 g or less. The DBP oil absorption of the carbon black of the first pigment is preferably 100 mL/100 g or more, more preferably 110 mL/100 g or more, and is preferably 180 mL/100 g or less. In particular, when the DBP oil absorption of the carbon black of the first pigment is less than 100 mL/100 g, the quantity of the surface-reflected light of an image is liable to be increased, and an improving effect on an optical density may be slightly decreased. The DBP oil absorption of the carbon black of the second pigment is preferably 95 mL/100 g or less, more preferably 90 mL/100 g or less, and preferably 40 mL/100 g or more. The DBP oil absorption of the carbon black may be measured by a method in conformity with JIS K 6221 and a method in conformity with ASTM D 2414. Those methods each involve: dropping dibutyl phthalate to 100 g of carbon black under stirring; and measuring the dropped amount of dibutyl phthalate at the time when a torque reaches its maximum.

### (Surfactant)

The ink includes the surfactant. As the surfactant, a nonionic surfactant and an anionic surfactant may each be used. When the cationic surfactant is used, the storage stability of the ink may be slightly decreased. The surfactant is preferably a nonionic surfactant. When the anionic surfactant is used, air bubbles generated in the ink may be easily stabilized, and when an image having a large ink consumption amount such as a solid image is continuously recorded, a suppressing effect on the non-ejection may be decreased.

Examples of the nonionic surfactant may include an acetylene glycol-based surfactant, a fluorine-based surfactant, a silicone-based surfactant and a polyoxyalkylene alkyl ether-based surfactant. The nonionic surfactant is preferably a polyoxyethylene alkyl ether out of those surfactants. When the polyoxyethylene alkyl ether is used, the wettability of the ink with respect to the constituent members of a recording head can be improved without a decrease in surface tension of the ink to an unnecessary degree. As a result, the ejection accuracy of the ink can be further improved while the optical density of the image is kept high.

The HLB value of the polyoxyethylene alkyl ether determined by Griffin's method is preferably 17.0 or less. When the HLB value of the polyoxyethylene alkyl ether is more than 17.0, the hydrophilic group may be too long, and the hydrophobic group does not easily adsorb to the surface of the particle of the carbon black. Then, when an image having a large ink consumption amount such as a solid image is continuously recorded, a suppressing effect on the non-ejection of the ink caused by the mixed air bubbles may be decreased. The HLB value of the polyoxyethylene alkyl ether determined by Griffin's method is preferably 11.0 or more. When the HLB value of the polyoxyethylene alkyl ether is less than 11.0, the solubility thereof into the ink is low, and the storage stability of the ink may be slightly decreased.

The HLB value may be calculated by the following formula (1). The HLB value determined by Griffin's method is a physical property value indicating the degree of hydrophilicity or lipophilicity of a surfactant, and takes a value of from 0.0 to 20.0. When the HLB value is smaller, the lipophilicity is higher. When the HLB value is larger, the hydrophilicity is higher.

HLB value=20×(formula weight of hydrophilic group of surfactant/molecular weight of surfactant) (1)

The polyoxyethylene alkyl ether has, for example, a structure represented by the following formula (2).

R—O—(CH₂CH₂O)ₙ—H (2)

(In the formula (2), R represents a hydrocarbon group, and “n” represents a natural number.)

The number of carbon atoms in the hydrocarbon group represented by R in the formula (2) generally falls within a range in which the polyoxyethylene alkyl ether exhibits surface activity. The number of the carbon atoms in the hydrocarbon group represented by the R in the formula (2) is preferably 12 or more to 22 or less. Examples of the hydrocarbon group represented by the R in the formula (2) may include alkyl groups, such as a lauryl group (12), a cetyl group (16), a stearyl group (18) and a behenyl group (22), and an alkenyl group such as an oleyl group (18) (the numerical values in parentheses indicate the number of the carbon atoms in the hydrocarbon group). In the formula (2), the “n” is a natural number that represents the number of repetitions of an ethylene oxide group. The value of the “n” is determined from the structure of the R and the HLB value. In the formula (2), the “n” is preferably 5 or more to 30 or less.

The content (% by mass) of the surfactant in the ink is preferably 0.05% by mass or more to 2.0% by mass or less, more preferably 0.05% by mass or more to 1.0% by mass or less with respect to the total mass of the ink. Different kinds of surfactants may be used together.

### (Water-Soluble Resin)

When the ink includes a water-soluble resin, it is preferable that the content thereof be not set to be too large. The water-soluble resin easily adsorbs to the surface of the particle of the self-dispersible carbon black. Thus, when the water-soluble resin is incorporated into the ink in a large amount, the aggregability of the self-dispersible carbon black may be decreased, and an improving effect on the optical density of an image may be slightly decreased. In addition, when the water-soluble resin is incorporated into the ink in a large amount, the adsorption of the surfactant to the hydrophobic portion of the surface of the particle of the self-dispersible carbon black may be inhibited. As a result, when an image having a large ink consumption amount such as a solid image is continuously recorded, a suppressing effect on the non-ejection of the ink caused by the mixed air bubbles may be decreased. When the water-soluble resin is incorporated into the ink, the content (% by mass) of the water-soluble resin in the ink is preferably set to 0.10% by mass or less with respect to the total mass of the ink. It is particularly preferable that the ink be free of a water-soluble resin.

A resin is generally made water-soluble by neutralization with a neutralizer, such as a hydroxide of an alkali metal (lithium, sodium, potassium or the like) or ammonia water. The expression “resin is water-soluble” as used herein means that a sample of a resin neutralized with an alkali equivalent to an acid value thereof does not form a particle whose particle diameter may be measured by a dynamic light scattering method. In addition, the expression “ink is free of a water-soluble resin” as used herein means that a trace amount of the water-soluble resin may be incorporated to the extent that the effect is not influenced.

### (Aqueous Medium)

The ink generally includes, as an aqueous medium, water or a mixed solvent of water and a water-soluble organic solvent. It is preferable that deionized water or ion-exchanged water be used as the water. In addition, any of known water-soluble organic solvents generally used in an ink for ink jet may be used as the water-soluble organic solvent. Examples of the water-soluble organic solvent may include monovalent or polyvalent alcohols, alkylene glycols each including an alkylene group having about 1 to 4 carbon atoms, and polyethylene glycols, glycol ethers and nitrogen-containing compounds each having a number-average molecular weight of from about 200 to about 2,000.

### (Other Components)

In addition to the above-mentioned components, the ink may also include an organic compound that is solid at normal temperature, such as trimethylolethane or trimethylolpropane, and a nitrogen-containing compound, such as urea or ethyleneurea, as required. In addition to the above-mentioned components, the ink may further include various additives, such as a pH adjuster, a rust inhibitor, an antiseptic, an antifungal agent, an antioxidant, an anti-reducing agent, an evaporation accelerator and a chelating agent, as required.

### (Physical Properties of Ink)

The static surface tension of the ink at 25° C. measured by a plate method is preferably 28 mN/m or more to 45 mN/m or less. The dynamic surface tension of the ink at a lifetime of 10 ms at 25° C. measured by a maximum bubble pressure method is preferably 45 mN/m or more, more preferably 50 mN/m or more. In addition, the dynamic surface tension of the ink at a lifetime of 10 ms at 25° C. measured by the maximum bubble pressure method is preferably 65 mN/m or less, more preferably 60 mN/m or less.

### <Ink Cartridge>

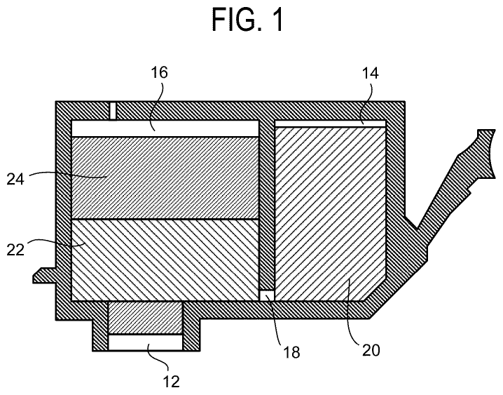

An ink cartridge of the present invention includes an ink and an ink storage portion configured to store the ink. In addition, the ink stored in the ink storage portion is the aqueous ink of the present invention described above. FIG. 1 is a sectional view for schematically illustrating the ink cartridge according to one embodiment of the present invention. As illustrated in FIG. 1, an ink supply port 12 for supplying an ink to a recording head is arranged on the bottom surface of the ink cartridge. The inside of the ink cartridge is the ink storage portion for storing the ink. The ink storage portion includes an ink storage chamber 14 and an absorbent storage chamber 16 and the chambers communicate to each other through a communication port 18. In addition, the absorbent storage chamber 16 communicates to the ink supply port 12. While a liquid ink 20 is stored in the ink storage chamber 14, absorbents 22 and 24 each configured to hold the ink in a state of being impregnated therewith are stored in the absorbent storage chamber 16. The ink storage portion may be a form that is free of any ink storage chamber configured to store the liquid ink and is configured to hold the total amount of the ink to be stored with the absorbents. In addition, the ink storage portion may be a form that is free of any absorbent and is configured to store the total amount of the ink in a liquid state. Further, an ink cartridge of a form formed to include the ink storage portion and a recording head may be adopted.

### <Ink Jet Recording Method>

An ink jet recording method of the present invention is a method including ejecting the aqueous ink of the present invention described above from a recording head of an ink jet system to record an image on a recording medium. A system of ejecting the ink is, for example, a system involving applying mechanical energy to the ink or a system involving applying thermal energy to the ink. In the present invention, the system involving applying the thermal energy to the ink to eject the ink is particularly preferably adopted. The step of the ink jet recording method only needs to be a known step except that the ink of the present invention is used.

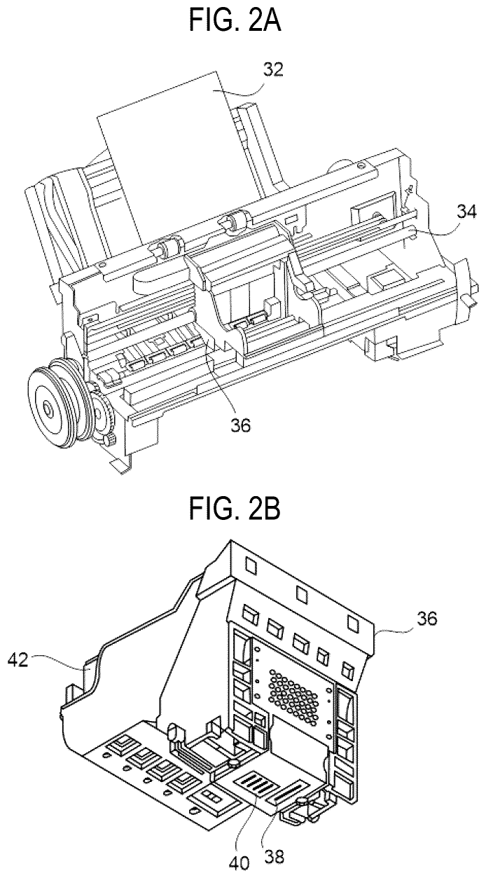

FIGS. 2A and 2B are views for schematically illustrating an example of an ink jet recording apparatus to be used in the ink jet recording method of the present invention. FIG. 2A is a perspective view of the main portion of the ink jet recording apparatus and FIG. 2B is a perspective view of a head cartridge. A conveying unit (not shown) configured to convey a recording medium 32 and a carriage shaft 34 are arranged in the ink jet recording apparatus. A head cartridge 36 may be mounted on the carriage shaft 34. The head cartridge 36 includes recording heads 38 and 40 and is formed so that an ink cartridge 42 may be set therein. While the head cartridge 36 is conveyed along the carriage shaft 34 in a main scanning direction, the ink (not shown) is ejected from the recording heads 38 and 40 toward the recording medium 32. Then, the recording medium 32 is conveyed by the conveying unit (not shown) in a sub-scanning direction. Thus, the image is recorded on the recording medium 32.

### EXAMPLES

The present invention is described in more detail below by way of Examples and Comparative Examples. However, the present invention is by no means limited to Examples below, and various modifications are possible without departing from the gist of the present invention. In the description of the amounts of components, “part(s)” and “%” are by mass unless otherwise specified.

### <Methods of Measuring Physical Properties>

### (Average Particle Diameter (Cumulative 50% Particle Diameter (D50) on Volume Basis) of Pigment)

A sample obtained by diluting each of pigment dispersion liquids with pure water was measured for an average particle diameter (cumulative 50% particle diameter (D50 (nm) on a volume basis)) of a pigment with a particle size analyzer based on a dynamic light scattering method. As the particle size analyzer, “NANOTRAC UPA-EX150” (product name) (manufactured by MicrotracBEL Corp.) was used. The measurement conditions were set as follows: SetZero: 30 seconds, number of times of measurement: three times, measurement time: 120 seconds, shape: non-sphere and refractive index: 1.80.

### (Anionic Group Amount of Pigment)

An anionic group amount of a pigment was measured by colloidal titration using a potential difference with a potentiometric automatic titration device (AT-510, manufactured by Kyoto Electronics Manufacturing Co., Ltd.) including a streaming potential titration unit (PCD-500). 5 mmol/L of methylglycol chitosan was used as a titration reagent.

### <Production of Water-Soluble Resin>

A four-necked flask with a stirring machine, a reflux condensing device and a nitrogen gas inlet tube was prepared. 200.0 Parts of ethylene glycol monobutyl ether was loaded into the four-necked flask, and a temperature in the flask was raised to 130° C. with stirring under a nitrogen gas atmosphere. 65.0 Parts of styrene, 20.0 parts of butyl acrylate, 15.0 parts of acrylic acid and 4.0 parts of t-butyl peroxide were added dropwise over 3 hours. After aging for 2 hours, ethylene glycol monobutyl ether was evaporated under reduced pressure. Thus, a resin was obtained. Potassium hydroxide in an amount equimolar to an acid value thereof and an appropriate amount of pure water were added to the resultant resin and heated to 80° C. to be dissolved therein. As a result, an aqueous solution of a water-soluble resin 1 in which the content of a water-soluble resin (solid content) was 20.0% was obtained.

### <Characteristics of Carbon Black (Pigment)>

Carbon blacks of the kinds shown in Table 1 were prepared. The characteristics of the carbon blacks are shown in Table 1.

TABLE 1
Table 1: Characteristics of carbon black

| | DBP oil absorption | Specific surface area |
|---|---|---|
| Pigment | (mL/100 g) | (m²/g) |
| 1 | 140 | 260 |
| 2 | 115 | 140 |
| 3 | 155 | 225 |
| 4 | 95 | 270 |
| 5 | 175 | 165 |
| 6 | 105 | 220 |
| 7 | 105 | 260 |
| 8 | 55 | 180 |
| 9 | 65 | 260 |
| 10 | 45 | 125 |
| 11 | 80 | 260 |
| 12 | 65 | 240 |
| 13 | 74 | 180 |
| 14 | 50 | 180 |

### <Preparation of Pigment Dispersion Liquid>

### (Pigment Dispersion Liquids 1 to 9, 13, 19 to 26, 28, 29 and 31)

A solution obtained by dissolving 5.0 g of concentrated hydrochloric acid in 5.5 g of pure water was brought into the state of being cooled to 5° C., followed by the addition of a treatment agent whose kind and usage amount (mmol) were shown in Tables 2-1 and 2-2 thereto under the state. A container containing the solution was loaded into an ice bath. While the temperature of the solution was held at 10° C. or less by stirring the solution, a solution obtained by dissolving 1.8 g of sodium nitrite in 9.0 g of ion-exchanged water at 5° C. was added thereto. After the mixture had been stirred for 15 minutes, 6.0 g of a pigment of each of the kinds shown in Tables 2-1 and 2-2 was added thereto under stirring and the whole was further stirred for 15 minutes to provide a slurry. After the resultant slurry had been filtered with filter paper (product name: “STANDARD FILTER PAPER No. 2”, manufactured by Advantec), its particle was sufficiently washed with water and dried in an oven at 110° C. A counter ion was substituted by an ion exchange method when it was required to obtain a counter ion of an anionic group shown in Tables 2-1 and 2-2. After that, an appropriate amount of pure water was added to the resultant to provide each pigment dispersion liquid.

### (Pigment Dispersion Liquid 10)

A self-dispersible pigment was prepared by subjecting the pigment 1 to surface oxidation treatment through use of an ozone gas with reference to the description of Example 3 in Japanese Patent Application Laid-Open No. 2003-535949. Specifically, first, the pigment 1 was preliminarily dispersed in ion-exchanged water and then subjected to ozone treatment for 2.5 hours. Next, while potassium hydroxide was added to adjust the pH of the mixture to about 7, the mixture was circulated for 2 hours with a liquid-liquid collision type disperser. After that, an appropriate amount of ion-exchanged water was added to the mixture to provide a pigment dispersion liquid 10.

### (Pigment Dispersion Liquid 11)

20 Grams of the pigment 1, 4.4 mmol of a ((4-aminobenzoylamino)-methane-1,1-diyl)bisphosphonic acid sodium salt, 7.5 mmol of nitric acid and 200 g of water were mixed. The mixture was stirred at 6,000 rpm under a room temperature condition with a Silverson mixer to provide a new mixture. 30 Minutes later, 7.5 mmol of sodium nitrite dissolved in a small amount of pure water was slowly added to be mixed with the resultant mixture. As a result, the temperature of the mixture reached 60° C., and the mixture was subjected to a reaction for 1 hour in this state. The pH of the mixture was adjusted to 10 through use of a 1.0 mol/L potassium hydroxide aqueous solution. 30 Minutes later, 20 mL of pure water was added to the mixture. Low-molecular-weight materials were removed through use of a spectrum membrane, and the residue was desalinated. An appropriate amount of pure water was added to the desalinated product to provide a pigment dispersion liquid 11.

### (Pigment Dispersion Liquid 12)

A solution obtained by dissolving 25.0 g of the pigment 1 and 10.8 mmol of sulfanilic acid in hot water was stirred until the temperature of the solution reached 30° C. 28.2 Millimoles of concentrated hydrochloric acid was added to the solution, and a solution obtained by dissolving 10.6 mmol of sodium nitrite in a small amount of water was added to the mixture over 1 hour. Pure water was added to the mixture, and the whole was stirred. After that, a potassium hydroxide aqueous solution was added to adjust the pH of the mixture to 9.0. After the water was evaporated in an oven until the content of the pigment reached 10.0%, the resultant was filtered through a 1.2 μm filter to provide a pigment dispersion liquid 12.

### (Pigment Dispersion Liquid 14)

20 Grams of the pigment 4, 2.6 mmol of a ((4-aminobenzoylamino)-methane-1,1-diyl)bisphosphonic acid sodium salt, 4.5 mmol of nitric acid and 200 g of water were mixed. The mixture was stirred at 6,000 rpm under a room temperature condition with a Silverson mixer to provide a new mixture. 30 Minutes later, 4.5 mmol of sodium nitrite dissolved in a small amount of pure water was slowly added to be mixed with the resultant mixture. As a result, the temperature of the mixture reached 60° C., and the mixture was subjected to a reaction for 1 hour in this state. The pH of the mixture was adjusted to 10 through use of a 1.0 mol/L potassium hydroxide aqueous solution. 30 Minutes later, 20 mL of pure water was added to the mixture. Low-molecular-weight materials were removed through use of a spectrum membrane, and the residue was desalinated. An appropriate amount of pure water was added to the desalinated product to provide a pigment dispersion liquid 14.

### (Pigment Dispersion Liquid 15)

10.0 Parts of the pigment 1, 15.0 parts of an aqueous solution of the water-soluble resin 1 and 75.0 parts of pure water were mixed to provide a mixture. The resultant mixture was loaded into a sand grinder and dispersed for 1 hour. After a coarse particle had been removed by centrifugation treatment, the residue was filtered with a microfilter having a pore size of 3.0 μm (manufactured by FUJIFILM Corporation) under pressure. An appropriate amount of pure water was added to the filtrate to adjust the content of the pigment. Thus, a pigment dispersion liquid 15 having a pigment content of 10.0% and a resin dispersant (water-soluble resin 1) content of 3.0% was obtained.

### (Pigment Dispersion Liquid 16)

A pigment dispersion liquid 16 was obtained in the same manner as in the method of preparing the “pigment dispersion liquid B” described in Japanese Patent Application Laid-Open No. 2002-003767 (Patent Literature 2) except that the pigment 6 was used.

### (Pigment Dispersion Liquid 17)

A pigment dispersion liquid 17 was obtained in the same manner as in the method of preparing the “pigment dispersion liquid 1” described in Japanese Patent Application Laid-Open No. 2018-021099 (Patent Literature 1) except that the pigment 7 was used.

### (Pigment Dispersion Liquid 18)

A pigment dispersion liquid 18 was obtained in the same manner as in the method of preparing the “pigment dispersion liquid 1” described in Japanese Patent Application Laid-Open No. 2018-149804 except that the pigment 1 was used.

### (Pigment Dispersion Liquid 27)

A pigment dispersion liquid 27 was obtained in the same manner as in the case of the above-mentioned pigment dispersion liquid 10 except that the pigment 8 was used instead of the pigment 1.

### (Pigment Dispersion Liquid 30)

A pigment dispersion liquid 30 was obtained in the same manner as in the case of the above-mentioned pigment dispersion liquid 15 except that the pigment 8 was used instead of the pigment 1.

### (Pigment Dispersion Liquid 32)

A pigment dispersion liquid 32 was obtained in the same manner as in the method of preparing the “pigment dispersion liquid A” described in Japanese Patent Application Laid-Open No. 2002-003767 (Patent Literature 2) except that the pigment 12 was used.

### (Pigment Dispersion Liquid 33)

A pigment dispersion liquid 33 was obtained in the same manner as in the method of preparing the “pigment dispersion liquid 7” described in Japanese Patent Application Laid-Open No. 2018-021099 (Patent Literature 1) except that the pigment 13 was used.

### (Pigment Dispersion Liquid 34)

A pigment dispersion liquid 34 was obtained in the same manner as in the method of preparing the “pigment dispersion liquid 11” described in Japanese Patent Application Laid-Open No. 2018-149804 except that the pigment 14 was used.

### (Characteristics of Pigment Dispersion Liquid)

The characteristics of the pigment dispersion liquids are shown in Tables 2-1 and 2-2.

TABLE 2-1
Preparation conditions and characteristics of pigment dispersion liquid

| | | Treatment agent | | Functional group of surface of |
|---|---|---|---|---|
| Pigment | | | Usage | particle of pigment |
| dispersion | | | amount | Structure |
| liquid | Pigment | Kind | (mmol) | (noted by acid type) |
| 1 | 1 | 4-Aminophthalic acid | 3.7 | —Ph—(COOH)₂ |
| 2 | 2 | 4-Aminophthalic acid | 3.7 | —Ph—(COOH)₂ |
| 3 | 3 | 4-Aminophthalic acid | 3.7 | —Ph—(COOH)₂ |
| 4 | 4 | 4-Aminophthalic acid | 3.7 | —Ph—(COOH)₂ |
| 5 | 5 | 4-Aminophthalic acid | 3.7 | —Ph—(COOH)₂ |
| 6 | 1 | 4-Aminophthalic acid | 4.4 | —Ph—(COOH)₂ |
| 7 | 1 | 4-Aminophthalic acid | 3.0 | —Ph—(COOH)₂ |
| 8 | 1 | 4-Aminophthalic acid | 2.4 | —Ph—(COOH)₂ |
| 9 | 1 | 4-Amino-1- | 4.4 | —Ph—COOH |
| | | benzenecarboxylic acid | | |
| 10 | 1 | — | | —COOH |
| 11 | 1 | — | | —Ph—CONH—CH(PO₃H₂)₂ |
| 12 | 1 | — | | —Ph—SO₃H |
| 13 | 1 | 4-Aminophthalic acid | 3.7 | —Ph—(COOH)₂ |
| 14 | 4 | — | | —Ph—CONH—CH(PO₃H₂)₂ |
| 15 | 1 | (Resin dispersed pigment) | | |
| 16 | 6 | 4-Amino-1- | — | —Ph—COOH |
| | | benzenecarboxylic acid | | |
| 17 | 7 | 4-Aminophthalic acid | — | —Ph—(COOH)₂ |
| 18 | 1 | 4-Aminophthalic acid | — | —Ph—(COOH)₂ |
| 19 | 8 | 4-Aminophthalic acid | 6.1 | —Ph—(COOH)₂ |
| 20 | 9 | 4-Aminophthalic acid | 6.1 | —Ph—(COOH)₂ |
| 21 | 10 | 4-Aminophthalic acid | 6.1 | —Ph—(COOH)₂ |
| 22 | 8 | 4-Aminophthalic acid | 4.4 | —Ph—(COOH)₂ |
| 23 | 8 | 4-Aminophthalic acid | 4.9 | —Ph—(COOH)₂ |
| 24 | 8 | 4-Aminophthalic acid | 6.6 | —Ph—(COOH)₂ |
| 25 | 8 | 4-Aminophthalic acid | 6.8 | —Ph—(COOH)₂ |
| 26 | 8 | 4-Amino-1- | 7.3 | —Ph—COOH |
| | | benzenecarboxylic acid | | |
| 27 | 8 | — | | —COOH |
| 28 | 8 | 4-Aminophthalic acid | 6.1 | —Ph—(COOH)₂ |
| 29 | 8 | 4-Aminophthalic acid | 6.8 | —Ph—(COOH)₂ |
| 30 | 8 | (Resin dispersed pigment) | | |
| 31 | 11 | 4-Aminophthalic acid | 6.1 | —Ph—(COOH)₂ |
| 32 | 12 | 4-Amino-1- | — | —Ph—COOH |
| | | benzenecarboxylic acid | | |
| 33 | 13 | 4-Aminophthalic acid | — | —Ph—(COOH)₂ |

| | | |
|---|---|---|
| 34 | 14 | (Resin dispersed pigment) |

TABLE 2-2
Characteristics of pigment dispersion liquid

| | Functional group of surface of | | Average | | |
|---|---|---|---|---|---|
| Pigment | particle of pigment | | particle | Content (%) | |
| dispersion | Counter ion of | Anionic group | diameter | | Resin |
| liquid | anionic group | amount (mmol/g) | (nm) | Pigment | dispersant |
| 1 | Potassium ion | 0.15 | 90 | 10.0 | 0.0 |
| 2 | Potassium ion | 0.15 | 80 | 10.0 | 0.0 |
| 3 | Potassium ion | 0.15 | 125 | 10.0 | 0.0 |
| 4 | Potassium ion | 0.15 | 75 | 10.0 | 0.0 |
| 5 | Potassium ion | 0.15 | 150 | 10.0 | 0.0 |
| 6 | Potassium ion | 0.18 | 90 | 10.0 | 0.0 |
| 7 | Potassium ion | 0.13 | 90 | 10.0 | 0.0 |
| 8 | Potassium ion | 0.10 | 90 | 10.0 | 0.0 |
| 9 | Potassium ion | 0.15 | 90 | 10.0 | 0.0 |
| 10 | Potassium ion | 0.15 | 90 | 10.0 | 0.0 |
| 11 | Potassium ion | 0.15 | 90 | 10.0 | 0.0 |
| 12 | Potassium ion | 0.15 | 90 | 10.0 | 0.0 |
| 13 | Ammonium ion | 0.15 | 90 | 10.0 | 0.0 |
| 14 | Potassium ion | 0.09 | 75 | 10.0 | 0.0 |
| 15 | (Resin dispersed pigment) | | 90 | 10.0 | 3.0 |
| 16 | Sodium ion | 0.34 | 70 | 10.0 | 0.0 |
| 17 | Potassium ion | 0.36 | 70 | 10.0 | 0.0 |
| 18 | Potassium ion | 0.36 | 90 | 10.0 | 0.0 |
| 19 | Potassium ion | 0.25 | 50 | 10.0 | 0.0 |
| 20 | Potassium ion | 0.25 | 60 | 10.0 | 0.0 |
| 21 | Potassium ion | 0.25 | 40 | 10.0 | 0.0 |
| 22 | Potassium ion | 0.18 | 50 | 10.0 | 0.0 |
| 23 | Potassium ion | 0.20 | 50 | 10.0 | 0.0 |
| 24 | Potassium ion | 0.27 | 50 | 10.0 | 0.0 |
| 25 | Potassium ion | 0.28 | 50 | 10.0 | 0.0 |
| 26 | Potassium ion | 0.25 | 50 | 10.0 | 0.0 |
| 27 | Potassium ion | 0.25 | 50 | 10.0 | 0.0 |
| 28 | Ammonium ion | 0.25 | 50 | 10.0 | 0.0 |
| 29 | Ammonium ion | 0.28 | 50 | 10.0 | 0.0 |
| 30 | (Resin dispersed pigment) | | 50 | 10.0 | 3.0 |
| 31 | Potassium ion | 0.25 | 68 | 10.0 | 0.0 |
| 32 | Sodium ion | 0.34 | 60 | 10.0 | 0.0 |
| 33 | Potassium ion | 0.36 | 63 | 10.0 | 0.0 |

| | | | | |
|---|---|---|---|---|
| 34 | (Resin dispersed pigment) | 50 | 10.0 | 6.0 |

### <Preparation of Surfactant>

Surfactants of the kinds shown in Table 3 were prepared. The characteristics of the surfactants are shown in Table 3. An HLB value is a value calculated by the above-mentioned Griffin's method. The “surfactant 8” and the “surfactant 9” are those manufactured by Kawaken Fine Chemicals Co., Ltd., and the other surfactants are those manufactured by Nikko Chemicals Co., Ltd.

TABLE 3
Table 3: Characteristics of surfactant

| | | | | HLB |
|---|---|---|---|---|
| Surfactant | Product name | Structure | Ionicity | value |
| 1 | NIKKOL BC-7 | Polyoxyethylene cetyl ether | Nonionic | 11.2 |
| 2 | NIKKOL BL-9 | Polyoxyethylene lauryl ether | Nonionic | 13.6 |
| 3 | NIKKOL BC-20 | Polyoxyethylene cetyl ether | Nonionic | 15.7 |
| 4 | NIKKOL BB-30 | Polyoxyethylene behenyl ether | Nonionic | 16.0 |
| 5 | NIKKOL BC-30 | Polyoxyethylene cetyl ether | Nonionic | 16.9 |
| 6 | NIKKOL BC-40 | Polyoxyethylene cetyl ether | Nonionic | 17.6 |
| 7 | NIKKOL BO-50 | Polyoxyethylene oleyl ether | Nonionic | 17.8 |
| 8 | Acetylenol E100 | Ethylene oxide adduct of | Nonionic | 13.3 |
| | | acetylene glycol | | |
| 9 | Acetylenol EH | Ethylene oxide adduct of | Nonionic | 13.3 |
| | | acetylene glycol | | |
| 10 | NIKKOL TLP-4 | Sodium polyoxyethylene | Anionic | — |
| | | lauryl ether phosphate | | |

### <Preparation of Ink>

The respective components (unit: % by mass) shown in the upper stages of Tables 4-1 to 4-6 were mixed, and the mixture was sufficiently stirred. After that, the resultant was filtered through a microfilter having a pore size of 3.0 μm (manufactured by FUJIFILM Corporation) under pressure to prepare each ink. The characteristics of the respective prepared inks are shown in the lower stages of Tables 4-1 to 4-6.

TABLE 4-1
Composition and characteristics of ink

| | Example | | | | | | | |
|---|---|---|---|---|---|---|---|---|
| | 1 | 2 | 3 | 4 | 5 | 6 | 7 | 8 |
| First pigment: kind of pigment dispersion | 1 | 1 | 2 | 3 | 1 | 1 | 4 | 2 |
| liquid | | | | | | | | |
| Second pigment: kind of pigment | 19 | 19 | 20 | 19 | 21 | 20 | 19 | 19 |
| dispersion liquid | | | | | | | | |
| Kind of surfactant | 3 | 3 + 8 | 3 | 3 | 3 | 3 | 3 | 3 |
| First pigment: usage amount of pigment | 30.00 | 30.00 | 30.00 | 30.00 | 30.00 | 30.00 | 30.00 | 30.00 |
| dispersion liquid | | | | | | | | |
| Second pigment: usage amount of | 10.00 | 10.00 | 10.00 | 10.00 | 10.00 | 10.00 | 10.00 | 10.00 |
| pigment dispersion liquid | | | | | | | | |
| Usage amount of surfactant | 0.50 | 0.50 | 0.50 | 0.50 | 0.50 | 0.50 | 0.50 | 0.50 |
| | | 0.10 | | | | | | |
| Water-soluble resin 1 | | | | | | | | |
| Glycerin | 10.00 | 10.00 | 10.00 | 10.00 | 10.00 | 10.00 | 10.00 | 10.00 |
| Triethylene glycol | 5.00 | 5.00 | 5.00 | 5.00 | 5.00 | 5.00 | 5.00 | 5.00 |
| 1,6-Hexanediol | 5.00 | 5.00 | 5.00 | 5.00 | 5.00 | 5.00 | 5.00 | 5.00 |
| Trimethylolpropane | | | | | | | | |
| Diethylene glycol | | | | | | | | |
| 2-Pyrrolidone | | | | | | | | |
| 1,2-Hexanediol | | | | | | | | |
| Ammonium benzoate | | | | | | | | |
| Pure water | 39.50 | 39.40 | 39.50 | 39.50 | 39.50 | 39.50 | 39.50 | 39.50 |
| Dynamic surface tension (mN/m) | 58 | 52 | 58 | 58 | 58 | 58 | 58 | 58 |
| D₁50 (nm) of first pigment | 90 | 90 | 80 | 125 | 90 | 90 | 75 | 80 |
| D₂50 (nm) of second pigment | 50 | 50 | 60 | 50 | 40 | 60 | 50 | 50 |
| Value (times) of D₁50/D₂50 | 1.8 | 1.8 | 1.3 | 2.5 | 2.3 | 1.5 | 1.5 | 1.6 |
| Anionic group amount S₁ (mmol/g) of first | 0.15 | 0.15 | 0.15 | 0.15 | 0.15 | 0.15 | 0.15 | 0.15 |
| pigment | | | | | | | | |
| Anionic group amount S₂ (mmol/g) of | 0.25 | 0.25 | 0.25 | 0.25 | 0.25 | 0.25 | 0.25 | 0.25 |
| second pigment | | | | | | | | |
| Value (times) of S₂/S₁ | 1.7 | 1.7 | 1.7 | 1.7 | 1.7 | 1.7 | 1.7 | 1.7 |
| Content P₁ (%) of first pigment | 3.00 | 3.00 | 3.00 | 3.00 | 3.00 | 3.00 | 3.00 | 3.00 |
| Content P₂ (%) of second pigment | 1.00 | 1.00 | 1.00 | 1.00 | 1.00 | 1.00 | 1.00 | 1.00 |
| Value (times) of P₁/P₂ | 3.0 | 3.0 | 3.0 | 3.0 | 3.0 | 3.0 | 3.0 | 3.0 |

TABLE 4-2
Composition and characteristics of ink

| | Example | | | | | | | |
|---|---|---|---|---|---|---|---|---|
| | 9 | 10 | 11 | 12 | 13 | 14 | 15 | 16 |
| First pigment: kind of pigment dispersion | 5 | 6 | 6 | 7 | 8 | 1 | 1 | 1 |
| liquid | | | | | | | | |
| Second pigment: kind of pigment | 19 | 22 | 23 | 19 | 19 | 22 | 24 | 25 |
| dispersion liquid | | | | | | | | |
| Kind of surfactant | 3 | 3 | 3 | 3 | 3 | 3 | 3 | 3 |
| First pigment: usage amount of pigment | 30.00 | 30.00 | 30.00 | 30.00 | 30.00 | 30.00 | 30.00 | 30.00 |
| dispersion liquid | | | | | | | | |
| Second pigment: usage amount of | 10.00 | 10.00 | 10.00 | 10.00 | 10.00 | 10.00 | 10.00 | 10.00 |
| pigment dispersion liquid | | | | | | | | |
| Usage amount of surfactant | 0.50 | 0.50 | 0.50 | 0.50 | 0.50 | 0.50 | 0.50 | 0.50 |
| Water-soluble resin 1 | | | | | | | | |
| Glycerin | 10.00 | 10.00 | 10.00 | 10.00 | 10.00 | 10.00 | 10.00 | 10.00 |
| Triethylene glycol | 5.00 | 5.00 | 5.00 | 5.00 | 5.00 | 5.00 | 5.00 | 5.00 |
| 1,6-Hexanediol | 5.00 | 5.00 | 5.00 | 5.00 | 5.00 | 5.00 | 5.00 | 5.00 |
| Trimethylolpropane | | | | | | | | |
| Diethylene glycol | | | | | | | | |
| 2-Pyrrolidone | | | | | | | | |
| 1,2-Hexanediol | | | | | | | | |
| Ammonium benzoate | | | | | | | | |
| Pure water | 39.50 | 39.50 | 39.50 | 39.50 | 39.50 | 39.50 | 39.50 | 39.50 |
| Dynamic surface tension (mN/m) | 58 | 58 | 58 | 58 | 58 | 58 | 58 | 58 |
| D₁50 (nm) of first pigment | 150 | 90 | 90 | 90 | 90 | 90 | 90 | 90 |
| D₂50 (nm) of second pigment | 50 | 50 | 50 | 50 | 50 | 50 | 50 | 50 |
| Value (times) of D₁50/D₂50 | 3.0 | 1.8 | 1.8 | 1.8 | 1.8 | 1.8 | 1.8 | 1.8 |
| Anionic group amount S₁ (mmol/g) of first | 0.15 | 0.18 | 0.18 | 0.13 | 0.10 | 0.15 | 0.15 | 0.15 |
| pigment | | | | | | | | |
| Anionic group amount S₂ (mmol/g) of | 0.25 | 0.18 | 0.20 | 0.25 | 0.25 | 0.18 | 0.27 | 0.28 |
| second pigment | | | | | | | | |
| Value (times) of S₂/S₁ | 1.7 | 1.0 | 1.1 | 1.9 | 2.5 | 1.2 | 1.8 | 1.9 |
| Content P₁ (%) of first pigment | 3.00 | 3.00 | 3.00 | 3.00 | 3.00 | 3.00 | 3.00 | 3.00 |
| Content P₂ (%) of second pigment | 1.00 | 1.00 | 1.00 | 1.00 | 1.00 | 1.00 | 1.00 | 1.00 |
| Value (times) of P₁/P₂ | 3.0 | 3.0 | 3.0 | 3.0 | 3.0 | 3.0 | 3.0 | 3.0 |

TABLE 4-3
Composition and characteristics of ink

| | Example | | | | | | | |
|---|---|---|---|---|---|---|---|---|
| | 17 | 18 | 19 | 20 | 21 | 22 | 23 | 24 |
| First pigment: kind of pigment dispersion | 1 | 1 | 1 | 1 | 9 | 10 | 11 | 12 |
| liquid | | | | | | | | |
| Second pigment: kind of pigment | 19 | 19 | 19 | 19 | 26 | 27 | 19 | 19 |
| dispersion liquid | | | | | | | | |
| Kind of surfactant | 3 | 3 | 3 | 3 | 3 | 3 | 3 | 3 |
| First pigment: usage amount of pigment | 23.30 | 24.00 | 33.30 | 34.00 | 30.00 | 30.00 | 30.00 | 30.00 |
| dispersion liquid | | | | | | | | |
| Second pigment: usage amount of | 16.70 | 16.00 | 6.70 | 6.00 | 10.00 | 10.00 | 10.00 | 10.00 |
| pigment dispersion liquid | | | | | | | | |
| Usage amount of surfactant | 0.50 | 0.50 | 0.50 | 0.50 | 0.50 | 0.50 | 0.50 | 0.50 |
| Water-soluble resin 1 | | | | | | | | |
| Glycerin | 10.00 | 10.00 | 10.00 | 10.00 | 10.00 | 10.00 | 10.00 | 10.00 |
| Triethylene glycol | 5.00 | 5.00 | 5.00 | 5.00 | 5.00 | 5.00 | 5.00 | 5.00 |
| 1,6-Hexanediol | 5.00 | 5.00 | 5.00 | 5.00 | 5.00 | 5.00 | 5.00 | 5.00 |
| Trimethylolpropane | | | | | | | | |
| Diethylene glycol | | | | | | | | |
| 2-Pyrrolidone | | | | | | | | |
| 1,2-Hexanediol | | | | | | | | |
| Ammonium benzoate | | | | | | | | |
| Pure water | 39.50 | 39.50 | 39.50 | 39.50 | 39.50 | 39.50 | 39.50 | 39.50 |
| Dynamic surface tension (mN/m) | 58 | 58 | 58 | 58 | 58 | 58 | 58 | 58 |
| D₁50 (nm) of first pigment | 90 | 90 | 90 | 90 | 90 | 90 | 90 | 90 |
| D₂50 (nm) of second pigment | 50 | 50 | 50 | 50 | 50 | 50 | 50 | 50 |
| Value (times) of D₁50/D₂50 | 1.8 | 1.8 | 1.8 | 1.8 | 1.8 | 1.8 | 1.8 | 1.8 |
| Anionic group amount S₁ (mmol/g) of first | 0.15 | 0.15 | 0.15 | 0.15 | 0.15 | 0.15 | 0.15 | 0.15 |
| pigment | | | | | | | | |
| Anionic group amount S₂ (mmol/g) of | 0.25 | 0.25 | 0.25 | 0.25 | 0.25 | 0.25 | 0.25 | 0.25 |
| second pigment | | | | | | | | |
| Value (times) of S₂/S₁ | 1.7 | 1.7 | 1.7 | 1.7 | 1.7 | 1.7 | 1.7 | 1.7 |
| Content P₁ (%) of first pigment | 2.33 | 2.40 | 3.33 | 3.40 | 3.00 | 3.00 | 3.00 | 3.00 |
| Content P₂ (%) of second pigment | 1.67 | 1.60 | 0.67 | 0.60 | 1.00 | 1.00 | 1.00 | 1.00 |
| Value (times) of P₁/P₂ | 1.4 | 1.5 | 5.0 | 5.7 | 3.0 | 3.0 | 3.0 | 3.0 |

TABLE 4-4
Composition and characteristics of ink

| | Example | | | | | | | |
|---|---|---|---|---|---|---|---|---|
| | 25 | 26 | 27 | 28 | 29 | 30 | 31 | 32 |
| First pigment: kind of pigment dispersion | 13 | 13 | 1 | 1 | 1 | 1 | 1 | 1 |
| liquid | | | | | | | | |
| Second pigment: kind of pigment | 28 | 19 | 19 | 19 | 19 | 19 | 19 | 19 |
| dispersion liquid | | | | | | | | |
| Kind of surfactant | 3 | 3 | 10 | 8 | 1 | 2 | 4 | 5 |
| First pigment: usage amount of pigment | 30.00 | 30.00 | 30.00 | 30.00 | 30.00 | 30.00 | 30.00 | 30.00 |
| dispersion liquid | | | | | | | | |
| Second pigment: usage amount of | 10.00 | 10.00 | 10.00 | 10.00 | 10.00 | 10.00 | 10.00 | 10.00 |
| pigment dispersion liquid | | | | | | | | |
| Usage amount of surfactant | 0.50 | 0.50 | 0.20 | 0.20 | 0.50 | 0.50 | 0.50 | 0.50 |
| Water-soluble resin 1 | | | | | | | | |
| Glycerin | 10.00 | 10.00 | 10.00 | 10.00 | 10.00 | 10.00 | 10.00 | 10.00 |
| Triethylene glycol | 5.00 | 5.00 | 5.00 | 5.00 | 5.00 | 5.00 | 5.00 | 5.00 |
| 1,6-Hexanediol | 5.00 | 5.00 | 5.00 | 5.00 | 5.00 | 5.00 | 5.00 | 5.00 |
| Trimethylolpropane | | | | | | | | |
| Diethylene glycol | | | | | | | | |
| 2-Pyrrolidone | | | | | | | | |
| 1,2-Hexanediol | | | | | | | | |
| Ammonium benzoate | | | | | | | | |
| Pure water | 39.50 | 39.50 | 39.80 | 39.80 | 39.50 | 39.50 | 39.50 | 39.50 |
| Dynamic surface tension (mN/m) | 58 | 58 | 48 | 48 | 56 | 56 | 58 | 60 |
| D₁50 (nm) of first pigment | 90 | 90 | 90 | 90 | 90 | 90 | 90 | 90 |
| D₂50 (nm) of second pigment | 50 | 50 | 50 | 50 | 50 | 50 | 50 | 50 |
| Value (times) of D₁50/D₂50 | 1.8 | 1.8 | 1.8 | 1.8 | 1.8 | 1.8 | 1.8 | 1.8 |
| Anionic group amount S₁ (mmol/g) of first | 0.15 | 0.15 | 0.15 | 0.15 | 0.15 | 0.15 | 0.15 | 0.15 |
| pigment | | | | | | | | |
| Anionic group amount S₂ (mmol/g) of | 0.25 | 0.25 | 0.25 | 0.25 | 0.25 | 0.25 | 0.25 | 0.25 |
| second pigment | | | | | | | | |
| Value (times) of S₂/S₁ | 1.7 | 1.7 | 1.7 | 1.7 | 1.7 | 1.7 | 1.7 | 1.7 |
| Content P₁ (%) of first pigment | 3.00 | 3.00 | 3.00 | 3.00 | 3.00 | 3.00 | 3.00 | 3.00 |
| Content P₂ (%) of second pigment | 1.00 | 1.00 | 1.00 | 1.00 | 1.00 | 1.00 | 1.00 | 1.00 |
| Value (times) of P₁/P₂ | 3.0 | 3.0 | 3.0 | 3.0 | 3.0 | 3.0 | 3.0 | 3.0 |

TABLE 4-5
Composition and characteristics of ink

| | Example | | | | Comparative Example | | | |
|---|---|---|---|---|---|---|---|---|
| | 33 | 34 | 35 | 36 | 1 | 2 | 3 | 4 |
| First pigment: kind of pigment dispersion | 1 | 1 | 1 | 14 | — | 1 | 15 | 1 |
| liquid | | | | | | | | |
| Second pigment: kind of pigment | 19 | 19 | 19 | 29 | 19 | — | 19 | 30 |
| dispersion liquid | | | | | | | | |
| Kind of surfactant | 6 | 7 | 3 | 10 | 3 | 3 | 3 | 3 |
| First pigment: usage amount of pigment | 30.00 | 30.00 | 30.00 | 23.30 | 0.00 | 40.00 | 30.00 | 30.00 |
| dispersion liquid | | | | | | | | |
| Second pigment: usage amount of | 10.00 | 10.00 | 10.00 | 16.70 | 40.00 | 0.00 | 10.00 | 10.00 |
| pigment dispersion liquid | | | | | | | | |
| Usage amount of surfactant | 0.50 | 0.50 | 0.50 | 0.20 | 0.50 | 0.50 | 0.50 | 0.50 |
| Water-soluble resin 1 | | | 0.50 | 0.50 | | | | |
| Glycerin | 10.00 | 10.00 | 10.00 | 10.00 | 10.00 | 10.00 | 10.00 | 10.00 |
| Triethylene glycol | 5.00 | 5.00 | 5.00 | 5.00 | 5.00 | 5.00 | 5.00 | 5.00 |
| 1,6-Hexanediol | 5.00 | 5.00 | 5.00 | 5.00 | 5.00 | 5.00 | 5.00 | 5.00 |
| Trimethylolpropane | | | | | | | | |
| Diethylene glycol | | | | | | | | |
| 2-Pyrrolidone | | | | | | | | |
| 1,2-Hexanediol | | | | | | | | |
| Ammonium benzoate | | | | | | | | |
| Pure water | 39.50 | 39.50 | 39.00 | 39.30 | 39.50 | 39.50 | 39.50 | 39.50 |
| Dynamic surface tension (mN/m) | 60 | 60 | 58 | 48 | 58 | 58 | 58 | 58 |
| D₁50 (nm) of first pigment | 90 | 90 | 90 | 75 | — | 90 | 90 | 90 |
| D₂50 (nm) of second pigment | 50 | 50 | 50 | 50 | 50 | — | 50 | 50 |
| Value (times) of D₁50/D₂50 | 1.8 | 1.8 | 1.8 | 1.5 | — | — | 1.8 | 1.8 |
| Anionic group amount S₁ (mmol/g) of first | 0.15 | 0.15 | 0.15 | 0.09 | — | 0.15 | — | 0.15 |
| pigment | | | | | | | | |
| Anionic group amount S₂ (mmol/g) of | 0.25 | 0.25 | 0.25 | 0.28 | 0.25 | — | 0.25 | — |
| second pigment | | | | | | | | |
| Value (times) of S₂/S₁ | 1.7 | 1.7 | 1.7 | 3.1 | — | — | — | — |
| Content P₁ (%) of first pigment | 3.00 | 3.00 | 3.00 | 2.33 | 0.00 | 4.00 | 3.00 | 3.00 |
| Content P₂ (%) of second pigment | 1.00 | 1.00 | 1.00 | 1.67 | 4.00 | 0.00 | 1.00 | 1.00 |
| Value (times) of P₁/P₂ | 3.0 | 3.0 | 3.0 | 1.4 | 0.0 | — | 3.0 | 3.0 |

TABLE 4-6
Composition and characteristics of ink

| | Comparative Example | | | | | | |
|---|---|---|---|---|---|---|---|
| | 5 | 6 | 7 | 8 | 9 | 10 | 11 |
| First pigment: kind of pigment dispersion | 15 | 2 | 1 | 1 | 16 | 17 | 18 |
| liquid | | | | | | | |
| Second pigment: kind of pigment | 30 | 31 | 31 | 19 | 32 | 33 | 34 |
| dispersion liquid | | | | | | | |
| Kind of surfactant | 3 | 3 | 3 | — | 9 | 7 | 3 |
| First pigment: usage amount of pigment | 30.00 | 30.00 | 30.00 | 30.00 | 45.00 | 29.97 | 20.00 |
| dispersion liquid | | | | | | | |
| Second pigment: usage amount of | 10.00 | 10.00 | 10.00 | 10.00 | 5.00 | 0.03 | 20.00 |
| pigment dispersion liquid | | | | | | | |
| Usage amount of surfactant | 0.50 | 0.50 | 0.50 | 0.00 | 0.20 | 0.15 | 0.30 |
| Water-soluble resin 1 | | | | | | | |
| Glycerin | 10.00 | 10.00 | 10.00 | 10.00 | 6.00 | 12.00 | 10.00 |
| Triethylene glycol | 5.00 | 5.00 | 5.00 | 5.00 | | 9.00 | 10.00 |
| 1,6-Hexanediol | 5.00 | 5.00 | 5.00 | 5.00 | | | |
| Trimethylolpropane | | | | | 6.00 | | |
| Diethylene glycol | | | | | 6.00 | | |
| 2-Pyrrolidone | | | | | | 2.00 | |
| 1,2-Hexanediol | | | | | | 1.00 | 0.20 |
| Ammonium benzoate | | | | | 1.50 | | |
| Pure water | 39.50 | 39.50 | 39.50 | 40.00 | 30.30 | 45.85 | 39.50 |
| Dynamic surface tension (mN/m) | 58 | 58 | 58 | 62 | 48 | 48 | 60 |
| D₁50 (nm) of first pigment | 90 | 80 | 90 | 90 | 70 | 70 | 90 |
| D₂50 (nm) of second pigment | 50 | 68 | 68 | 50 | 60 | 63 | 50 |
| Value (times) of D₁50/D₂50 | 1.8 | 1.2 | 1.3 | 1.8 | 1.2 | 1.1 | 1.8 |
| Anionic group amount S₁ (mmol/g) of first | — | 0.15 | 0.15 | 0.15 | 0.34 | 0.36 | 0.36 |
| pigment | | | | | | | |
| Anionic group amount S₂ (mmol/g) of | — | 0.25 | 0.25 | 0.25 | 0.34 | 0.36 | — |
| second pigment | | | | | | | |
| Value (times) of S₂/S₁ | — | 1.7 | 1.7 | 1.7 | 1.0 | 1.0 | — |
| Content P₁ (%) of first pigment | 3.00 | 3.00 | 3.00 | 3.00 | 4.50 | 2.997 | 2.00 |
| Content P₂ (%) of second pigment | 1.00 | 1.00 | 1.00 | 1.00 | 0.50 | 0.003 | 2.00 |
| Value (times) of P₁/P₂ | 3.0 | 3.0 | 3.0 | 3.0 | 9.0 | 999.0 | 1.0 |

### <Evaluation>

The respective evaluations as shown below were performed by using the respective prepared inks. In the present invention, in the evaluation criteria of each of the evaluation items described below, while levels “A” and “B” were defined as acceptable levels, a level “C” was defined as an unacceptable level. The evaluation results are shown in Table 5.

### (Optical Density)

Each of the prepared inks was filled into an ink cartridge, and the ink cartridge was set in an ink jet recording apparatus (product name: “PIXUS PRO-10S”, manufactured by Canon Inc.) including a recording head that ejected an ink through action of thermal energy. In this Example, the recording duty of an image recorded under the following condition is defined as 100%: eight ink droplets each having a mass per droplet of 3.5 ng are applied to a unit region measuring 1/600 inch by 1/600 inch. The recording environment was set to a temperature of 25° C. and a relative humidity of 55%. A solid image having a recording duty of 50% was recorded on the entire surface of plain paper of A4 size (product name: “CS-064”, manufactured by Canon Inc.) with the above-mentioned ink jet recording apparatus. After the lapse of 1 day from the recording, the optical density of the image was measured with a spectrophotometric colorimeter (product name: “FD-7”, manufactured by Konica Minolta, Inc.), and the optical density of the image was evaluated in accordance with the following evaluation criteria.

A: The optical density was 1.2 or more.

B: The optical density was 1.1 or more to less than 1.2.

C: The optical density was less than 1.1.

### (Ejection Stability)

A solid image having a recording duty of 100% was continuously recorded on the entire surfaces of 10 sheets of plain paper of A4 size (product name: “CS-064”, manufactured by Canon Inc.) under the same conditions as those for the evaluation in the above-mentioned section “Optical Density.” After that, a nozzle check pattern of “PIXUS PRO-10S” was recorded on plain paper of A4 size (product name: “CS-064”, manufactured by Canon Inc.) through use of 768 ejection orifices of the recording head. Then, the number of ejection orifices in which the non-ejection of the ink occurred out of the 768 ejection orifices was counted, and the ejection stability of the ink was evaluated in accordance with the following evaluation criteria.

A: There were no ejection orifices in which the non-ejection occurred.

B: There were one to three ejection orifices in which the non-ejection occurred.

C: There were four or more ejection orifices in which the non-ejection occurred.

### (Ejection Accuracy)

A solid image having a recording duty of 50% was recorded on the entire surfaces of 5 sheets of plain paper of A4 size (product name: “CS-064”, manufactured by Canon Inc.) under the same conditions as those for the evaluation in the above-mentioned section “Optical Density.” After that, a nozzle check pattern of “PIXUS PRO-10S” was recorded on plain paper of A4 size (product name: “CS-064”, manufactured by Canon Inc.). The resultant nozzle check pattern was visually checked, and the states of the ejection orifices of the recording head were observed with a microscope. The ejection accuracy of the ink was evaluated in accordance with the following evaluation criteria.

A: There was no adhesion of ink droplets to the vicinity of the ejection orifices, and the nozzle check pattern was not disturbed.

B: There was adhesion of ink droplets to the vicinity of the ejection orifices, but the nozzle check pattern was not disturbed.

C: There was adhesion of ink droplets to the vicinity of the ejection orifices, and the nozzle check pattern was disturbed.

TABLE 5
Table 5: Results of evaluation

| | | Optical | Ejection | Ejection |
|---|---|---|---|---|
| | | density | stability | accuracy |
| Example | 1 | A | A | A |
| | 2 | A | A | A |
| | 3 | A | A | A |
| | 4 | A | A | A |
| | 5 | A | A | A |
| | 6 | A | A | A |
| | 7 | B | A | A |
| | 8 | A | A | A |
| | 9 | A | A | A |
| | 10 | B | A | A |
| | 11 | A | A | A |
| | 12 | A | A | A |
| | 13 | B | A | A |
| | 14 | A | A | A |
| | 15 | A | A | A |
| | 16 | A | B | A |
| | 17 | B | A | A |
| | 18 | A | A | A |
| | 19 | A | A | A |
| | 20 | A | B | A |
| | 21 | A | A | A |
| | 22 | B | A | A |
| | 23 | B | A | A |
| | 24 | B | A | A |
| Example | 25 | A | A | A |
| | 26 | B | A | A |
| | 27 | B | B | B |
| | 28 | B | A | A |
| | 29 | A | A | A |
| | 30 | A | A | A |
| | 31 | A | A | A |
| | 32 | A | A | A |
| | 33 | A | B | A |
| | 34 | A | B | A |
| | 35 | B | B | A |
| | 36 | B | B | B |
| Comparative | 1 | C | C | A |
| Example | 2 | A | C | A |
| | 3 | C | C | A |
| | 4 | B | C | A |
| | 5 | C | C | A |
| | 6 | A | C | A |
| | 7 | A | C | A |
| | 8 | A | A | C |
| | 9 | A | C | A |
| | 10 | A | C | A |
| | 11 | B | C | A |

According to the present invention, the aqueous ink for ink jet capable of recording an image having a high optical density, in which the non-ejection of the ink is less liable to occur, even when an image having a large ink consumption amount is continuously recorded, can be provided. In addition, according to the present invention, the ink cartridge and the ink jet recording method each using the aqueous ink can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-044876, filed Mar. 21, 2024, and Japanese Patent Application No. 2025-024416, filed Feb. 18, 2025, which are hereby incorporated by reference herein in their entirety.

What is claimed is:

1. An aqueous ink for ink jet comprising:
a first pigment;
a second pigment; and
a surfactant,
wherein the first pigment and the second pigment are each self-dispersible carbon black in which an organic group comprising an anionic group is bonded to a surface of a particle of carbon black, and
wherein a ratio of a cumulative 50% particle diameter (nm) of the first pigment on a volume basis to a cumulative 50% particle diameter (nm) of the second pigment on a volume basis is 1.3 times or more, and the cumulative 50% particle diameter of the second pigment on a volume basis is 60 nm or less.

2. The aqueous ink according to claim 1, wherein the cumulative 50% particle diameter of the first pigment on a volume basis is 80 nm or more.

3. The aqueous ink according to claim 1, wherein a ratio of an anionic group amount (mmol/g) of the second pigment to an anionic group amount (mmol/g) of the first pigment is 1.1 times or more to 2.0 times or less.

4. The aqueous ink according to claim 1, wherein the second pigment has an anionic group amount (mmol/g) of 0.27 mmol/g or less.

5. The aqueous ink according to claim 1, wherein a mass ratio of a content (% by mass) of the first pigment to a content (% by mass) of the second pigment is 1.5 times or more to 5.0 times or less.

6. The aqueous ink according to claim 1, wherein the anionic groups of the first pigment and the second pigment are each a carboxylic acid group.

7. The aqueous ink according to claim 1,
wherein the anionic group has a counter ion, and
wherein the counter ion is one of a potassium ion and an ammonium ion, and the counter ions of the first pigment and the second pigment are the same kind.

8. The aqueous ink according to claim 1, wherein the surfactant is a nonionic surfactant.

9. The aqueous ink according to claim 8, wherein the nonionic surfactant is a polyoxyethylene alkyl ether.

10. The aqueous ink according to claim 9, wherein the polyoxyethylene alkyl ether has an HLB value determined by Griffin's method of 17.0 or less.

11. The aqueous ink according to claim 1, wherein the aqueous ink is free of a water-soluble resin.

12. An ink cartridge comprising:
an ink; and
an ink storage portion configured to store the ink,
wherein the ink comprises the aqueous ink of claim 1.

13. An ink jet recording method comprising ejecting an ink from a recording head of an ink jet system to record an image on a recording medium,
wherein the ink comprises the aqueous ink of claim 1.
